(19) United States
(12) Patent Application Publication
(10) Pub. No.: US 2025/0009180 A1
(43) Pub. Date: Jan. 9, 2025

(54) SYSTEMS AND METHODS OF INTEGRATING GRILLING AND STEAMING

(71) Applicant: PI Grill Inc., Santa Fe Springs, CA (US)

(72) Inventor: Enjun YING, Santa Fe Springs, CA (US)

(21) Appl. No.: 18/217,852

(22) Filed: Jul. 3, 2023

(51) Int. Cl. A47J 37/07; A47J 27/04; A47J 36/32; F24C 1/04

(52) U.S. Cl. CPC A47J 37/0786; A47J 27/04; A47J 36/321; A47J 37/0704; F24C 1/04; A47J 2027/043

(57) ABSTRACT

Embodiments include methods, system, storage medium, and computer program to integrate grilling and steaming in a grill system. In one embodiment, a grill comprises: a heat source to provide heat to a cooking surface; the cooking surface to receive the heat generated by the heat source and to place food to be cooked; a liquid box coupled to the heat source, wherein the liquid box is below the cooking surface and to receive liquid to be heated by the heat source and to produce steam to cook the food; a waste collector to collect wastes produced from cooking the food; an enclosure to enclose the heat source, the cooking surface, the liquid box; and the waste collector; a control panel, the control panel to receive commands wirelessly to control how the food is to be cooked; and a power source to provide electricity to the control panel.

### TECHNICAL FIELD

Embodiments of the invention relate to systems and methods that integrate grilling and steaming.

### BACKGROUND ART

A grill is a cooking appliance that used for grilling food. The grill may be used indoor and outdoor, and it includes a cooking surface that is heated from below, by heating materials. Grilling involves direct heat applied to food and often resulting in a distinctive smoked, charred or seared appearance and flavor.

Grilling has a long history and many grill systems have been on the market over the years. Yet another cooking method with competing popularity is streaming. Steam cooking is based on the evaporation process. When liquid is heated, its temperature rises, and it reaches its boiling point eventually. At this point, the liquid undergoes a phase change and turns into vapor, known as steam, and the steam, as moist heat, is used to cook food.

The popularity of cooking methods can vary significantly between different regions, cultures, and individual preferences, but it is undisputable that steaming is an important cooking method and has its benefits. For example, with steam surrounding the food, steaming allows better preservation of flavor and texture, cooks food more evenly, and retains more moisture in the food. Yet even through steaming has its unique advantages, existing grill systems do not integrate well with steam cooking.

### SUMMARY OF THE INVENTION

Embodiments include methods, system, storage medium, and computer program to integrate grilling and steaming in a grill system. In one embodiment, a grill comprises: a heat source to provide heat to a cooking surface; the cooking surface to receive the heat generated by the heat source and to place food to be cooked; a liquid box coupled to the heat source, wherein the liquid box is below the cooking surface and to receive liquid to be heated by the heat source and to produce steam to cook the food; a waste collector to collect wastes produced from cooking the food; an enclosure to enclose the heat source, the cooking surface, the liquid box; and the waste box; a control panel, the control panel to receive commands wirelessly to control how the food is to be cooked; and a power source to provide electricity to the control panel.

By implementing embodiments as described, a grill system can integrate grilling and steaming in a single system. Both steaming and grilling may be controlled wirelessly and together they provide a better cooking experience than existing systems.

### BRIEF DESCRIPTION OF THE DRAWINGS

The invention may best be understood by referring to the following description and accompanying drawings that are used to illustrate embodiments of the invention. In the drawings:

FIG. 1 illustrates a grill system with integrated steaming capability per some embodiments.

FIG. 2 illustrates a grill with integrated steaming capability per some embodiments.

FIG. 3 illustrates an internal view of a grill with integrated steaming capability per some embodiments.

FIG. 4 illustrates a cross-section view of the grill with integrated steaming capability as shown in FIG. 3.

FIGS. 5A-5B illustrate two views of an air flow vent in the grill with integrated steaming capability as shown in FIG. 3.

FIGS. 6A-6D illustrate user interfaces to manage a grill system with integrated steaming capability per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

Other objectives, features, and advantages of the enclosed embodiments will be apparent from the following description.

### Grill Integrating Grilling and Steaming

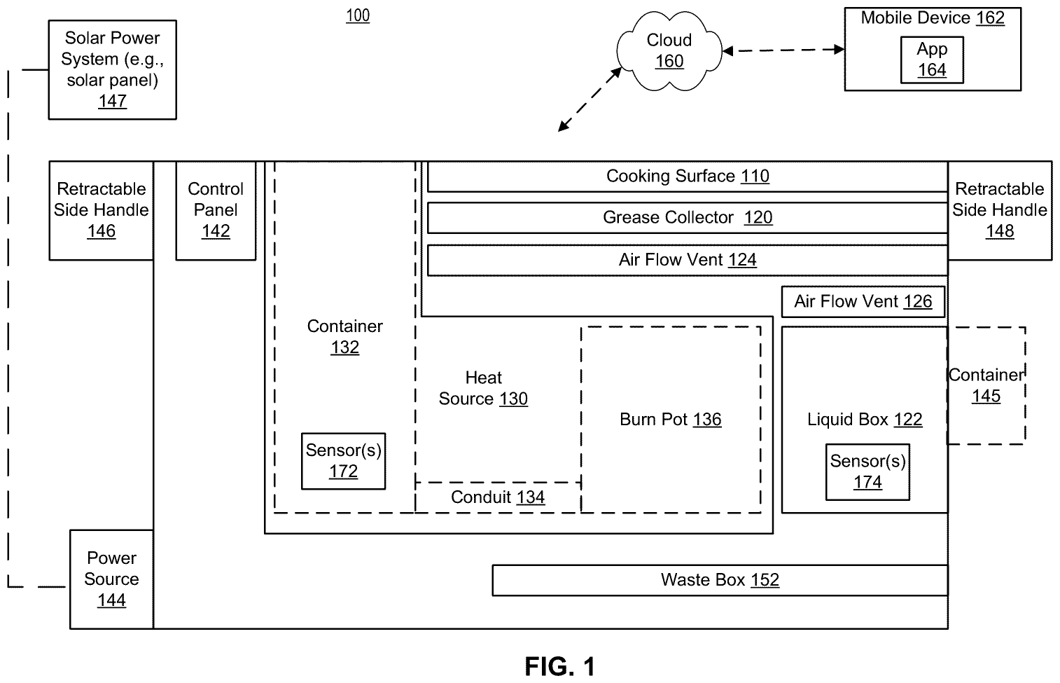

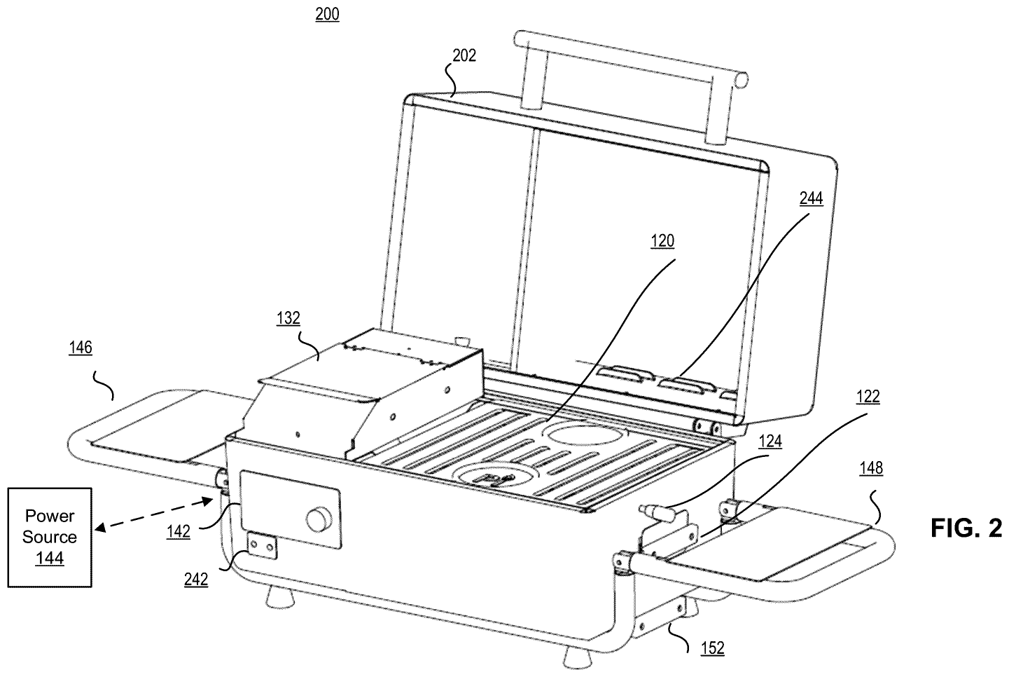

Embodiments include methods, system, storage medium, and computer program to ingerate grilling and steaming in a grill system. FIG. 1 illustrates a grill system with integrated steaming capability per some embodiments. The grill system 100 includes a physical grill to cook food and the peripheral hardware and software to enhance the cooking experience. The physical grill includes a enclosure that encloses components to cook food. The enclosure includes a cover (not shown in FIG. 1 but shown in FIG. 2 at reference 202) and a body that includes entities to cook and to control the cooking.

The body of the physical grill includes a cooking surface 110 to place food to be cooked. The cooking surface 110 can be a flat, solid surface, or a gridiron with parallel bars or slats, and may be referred to a griddle or grate. The cooking surface 110 may be made of cast iron, stainless steel, or another durable material. A variety of foods may be placed on the cooking surface 110 to cook, including meats (e.g., steaks, hamburgers, hot dogs, sausages, chicken breasts, pork chops, lamb chops, and ribs), seafood (e.g., salmon, trout, tilapia, shrimp, scallops, lobster tails, and even whole fish), vegetables (e.g., bell peppers, zucchini, eggplant, asparagus, corn on the cob, mushrooms, onions, and tomatoes), fruits (e.g., pineapple, peaches, watermelon, apples, and bananas), cheese (e.g., halloumi, paneer, and queso blanco), and bread. The food types to be cooked on a grill are endless and vary based on regions, cultures, and individual preferences. The embodiments discussed herein are not limited to a particle type of food.

A grease collector 120 is to be placed beneath the cooking surface 110 to collect and manage the grease and drippings that occur during cooking. Grease refers to the fat and/or oil that are rendered or expelled from the food as it cooks, while drippings refer to the liquid that falls or drips from the food being cooked on the grill. Additionally, the grease collector 120 helps prevent fire flare-ups and keep the grill clean. The grease collector 120 may be referred to by different names, e.g., grease tray or grease bucket. The grease collector 120 is included within the enclosure that encloses the grill in some embodiments. Additionally, in some embodiments, instead of being directly beneath the cooking surface 110, the grease collector 120 may be placed at other places within the enclosure and the grease/drippings from the the cooking surface 110 (or elsewhere) are channeled to the grease collector location via a conduit. By not exposing the grease/dripping outside of the grill, these embodiments offer better aesthetic appeal.

An air flow vent 124 is to be placed beneath the cooking surface 110 to regulate the air flow, temperature, smoke level, and/or steam within the grill during the cooking process. The regulation of the air flow, temperature, smoke level, and/or steam by the air flow vent 124 adjusts the heat level that may reach the cooking surface 110. An air flow vent in a grill may also be referred to as a damper, a draft control, or a flue.

The air flow vent 124 includes one or more apertures or passage through which air, smoke, steam, or other substances can flow through. The apertures or passage may be in a variety of shapes (e.g., circular or rectangular), and these shapes may form various patterns, e.g., grid/mesh with a series of small openings or a mesh pattern, or a series of enlonged openings with narrow slots.

These apertures or passage may be adjusted, e.g., by sliding or rotating a damper mechanism to enlarge or reduce the sizes and/or shape of the aperture. The apertures or passage may be formed by one or more flaps, each of which is a flexible or movable piece that can cover an opening and be attached by a hinge or another means to swing or move. Additionally, the apertures or passage may be formed by one or more slats, each of which is a thin, narrow piece of metal or another solid material fitting each other as in a window blind, and the slats may be tilted to an angle (from e.g., one in the range of zero to 90 degrees) to change the direction of air flow through the corresponding aperture. The adjustment may be performed manually by an operator of the grill, and/or automatically through a motor that is controlled, e.g., by a control panel such as control panel 142. The air flow vent 124 can thus change the direction of the air flow within the grill.

While air flow vent 124 controls the heat level and/or direction through adjusting the air flow, an air flow vent 126 may be implemented to change the level and/or direction of steam generated from the liquid box 122. The air flow vent 126 can have the same or a different design comparing to the air flow vent 124 in the same grill, and the apertures or passage of the air flow vent 126 can be any of the ones discussed herein, and they are adjustable similar to those of the air flow vent 124. In the embodiment as shown, air flow vent 124 controls the overall heat level and/or direction within grill, and air flow vent 126 controls the level and/or direction of steam; but in an alternative embodiment, air flow vent 124 may control only the heat level and/or direction from the burn pot 136, and does not affect the heat generated from steam of liquid box 122.

Note that even though only two air flow vents are shown in the figure, a grill may have multiple other air flow vents in other locations. For example, an air intake vent, along with a fan, may regulate the flow of oxygen into the grill for cooking. An exhaust vent, also referred to as chimney vent/damper, may regulate the flow of air, smoke, and/or steam out of the grill.

A heat source 130 provides the heat to the cooking surface 110. In some embodiments, the heat source 130 includes a burn pot 136 to burn heating materials to provide the heat to cooking surface 110 to cook the food, a container 132 store the heating materials, a conduit 134 to provide the heating materials to the burn pot 136. The heat source 130 may provide different levels of heat temperatures. For example, the heat termperatures may in one of the following modes and temperature ranges: (1) smoke mode, the heat temperate in the (low) range of 180 to 250 Fahrenheits (° F.) (82 to 212 Celsiuses (° C.)); (2) roast mode, the heat temperate in the (medium) range of 250 to 350 Fahrenheits (° F.) (121 to 176 Celsiuses (° C.)); or (3) sear mode, the heat temperate in the (high) range of 350 to 500 Fahrenheits (° F.) (176 to 260 Celsiuses (° C.)). Other modes and temperature ranges may be supported as well.

The container 132 may store a variety of heating materials such as wood pellets, charcoal, propane or natural gas, or a combination of wood pellets, charcoal, propane or natural gas. Other heating materials may also be used in the grill, and embodiments of the disclosure are not limited to a particular type of heating material. One or more sensors 172 may be implemented for the container 132 and measure whether the heating materials are sufficient to cook the food in some embodiments. The sensors 172 may measure the current volume of the heating materials and the rate of consumption by the burn pot 136 and determine whether the the remaining heating materials are sufficient. The status of sufficiency may be provided for control and management, e.g., to a control panel such as control panel 142. Based on the status, more heating materials may then be added to the container 132 when the remaining heating materials are insufficient.

Different heat temperatures provided by the burn pot 136 correspond to different consumption rates and the sensors 172 may detect the volume change and determine the status of sufficiency.

The burn pot 136 may also be referred to as fire pot, combustion chamber or chamber, burner, or firebox. It may be located toward the bottom of the grill, and the heating materials are ignited and burned to generate heat and smoke in the burn pot 136. An ignition mechanism (e.g., using ignition rod or hot element) may be implemented to ignite the heating materials. The heat generated from the burn pot 136 is distributed throughput the grill via conduction, convection, or radiant heat, or a combination of two or more. The heat may be adjusted, as discussed herein, by air flow vent 124.

Conduction heat refers to the transfer of heat directly between two solid objects in contact with each other. For example, conduction heat occurs when the food comes into direct contact with the hot cooking surface 110. Convection heat refers to the transfer of heat through the movement of a fluid, such as air or smoke. In a grill, convection heat occurs as the hot air or smoke circulates around the food. Radiant heat refers to the transfer of heat energy through electromagnetic waves, where the radio heat travels in the form of electromagnetic radiation, primarily in the infrared spectrum.

A waste box 152 may be implemented to collect byproducts (e.g., ashes and debris) from burning the heating materials. The waste box 152 may also be referred to as ash/waste drawer, collection pan/cup, and ash pan/tryay/bucket/catcher. The waste box 152 is included within the enclosure that encloses the grill in some embodiments. By not exposing the waste box 152 outside of the grill, these embodiments offer better aesthetic appeal.

While the waste box 152 and grease collector 120 are shown as separate entities in the grill, they may be integrated into a single entity. The entity that performs the functions of the waste box 152 and grease collector 120 is referred to as waste collector herein and it collects and manages the grease, drippings, and/or byproducts from burning the heating materials.

A liquid box 122 may be coupled to the heat source 130 in some embodiments. For example, the liquid box 122 may be placed next to the burn pot 136 so the former may receive heat generated from the burn pot 136 via conduction, convection, and/or radiant heat. The liquid box 122 may be placed further away from the burn pot 136, which then propagates to the liquid box 122 through a conduit.

The liquid box 122 may store any liquid that can be used in cooking, including one or more of water, broth, vinegar, milk (animal-based or planet-based), marinade, sauce (e.g., soy sauce), marinade, juice, liquor (e.g., beer, wine, or hard liquor). Each type of liquids can have many subtypes. For example, hard liquor, also referred to as spirits or distilled spirits, includes whiskey, vodka, rum, tequila, gin, brandy, and liqueurs.

The liquid stored in the liquid box 122 can be used to steam cook the food on the cooking surface 110. Steaming has its health benefits based on its ability to retain the nutritional value of food. Other than health benefits, steaming retents moisture in food, and when steaming is done with different liquids, different flavors may be infused into food as well.

In some embodiments, one or more sensors 174 is implemented for the liquid box 122. The sensors may include one that measures whether the liquid in the liquid box is sufficient to cook the food on the cooking surface 110. The sensors 174 may measure the current volume of the liquid in the liquid box 122 and the flow rate of the liquid box 122 during steaming, and determine whether the the remaining liquid in the liquid box 122 is sufficient to cook the food. The status of sufficiency may be provided for control and management, e.g., to a control panel such as control panel 142. Based on the status, more liquid may then be added to the liquid box 122 when the remaining liquid in the liquid box is insufficient.

In some embodiments, the liquid box 122 is coupled to another container 145 that is accessible during food cooking and without opening the grid. The container 145 may contain the liquid that can be fed into the liquid box 122 when the liquid in the liquid box is determined to be insufficient. The container 145 can be replaced when emptied so the replaced container 145 can still feed the liquid box 122 during the food cooking. Additionally, the container 145 may contain different liquids to be used at different stages of cooking, so once the sensors 174 determine that the current liquid in the liquid box 122 has been used up (or at a certain level), another type of liquid may be added for the next stage of cooking.

In addition to the sensor to determine whether the liquid in the liquid box is sufficient to cook the food, other sensors may be implemented for the liquid box 122 as well. For example, one sensor may be implement to measure the temperature of the liquid within the liquid box 122. The measured temperature may be compared to the boiling point of the liquid to determine when the corresponding steam may be generated thus the time to steaming cook the food may be determined.

While only one liquid box 122 is shown, multiple liquid boxes with the same or different liquid types may be implemented in the grill. When multiple liquid boxes are implemented, each may have its own container 145 to be coupled with. Different types of liquids have different boiling points, and liquid in different liquid boxes may reach the same boiling point at different time based on a variety of factors (e.g., the distances to the heat source 130). By arranging the liquids in different liquid boxes, a user may achieve different flavors through the steaming. While a single air flow vent 126 may be implemented for all of the liquid boxes, alternative embodiments may implement individual air flow vent for each liquid box to control the level and direction of steam generated from each liquid box.

A control panel 142 is implemented on the grill to control how the food is to be cooked in the grill. The control panel 142 may include a panel with one or more of graphic user interface (GUI) (e.g., touch screen), button(s), or knob(s), through which the user may (1) view the current statuses of the cooking based on the data collected from grills (e.g., through sensors and probes), and/or (2) enter settings to control the food cooking. For example, the control panel may determine the cooking temperature, the cooking mode, and control the operations of various components of the the grill, including the air flow vent 124/126, heat source 130, liquid box 122, grease collector 120 and waste box 152.

Note that the control panel 142 may control components and entities not shown in the figure. For example, even through only two sets of sensors are shown as sensors 172 and 174, other sensors may be implemented in the grill, including temperature sensors (e.g., thermometers) at various locations within the grill to measure the cooking temperature. Additionally, the grill may be portable, and it may include sensors used in mobile device so the location/environment of the grill may be determined, the sensors include (1) accelerometer to measure the grill's acceleration, tilt, and orientation, (2) gyroscope to measure the grill's angular velocity and rotation, (3) magnetometer to detect magnetic fields and determines the device's orientation relative to the Earth's magnetic north, (4) ambient light sensor to measure the ambient light level in the surroundings of the grill, (5) positioning sensor such as Global Positioning System (GPS). The control panel 142 may provide authentication functionality and include fingerprint sensor to capture and verify fingerprint for secure authentication and unlocking the control panel. It may also include face recognition sensor to scan and analyze facial features to provide biometric authentication and face unlocking capabilities.

Additionally, the control panel 142 may include or coupled to probes to measure the internal temperature of the food being cooked. The probes may be referred to as meat probe, food probe, or food thermometer and they may be built in and the reading can be displayed through the control panel 142.

While a user of the grill may enter settings on the control panel 142 to control the food cooking, an application (also referred to as an app) 164 may be designed as a software program specifically designed to run on a mobile device 162, e.g., smartphone, tablet, smart watch, laptop computer. The application 164 may provide an GUI for a user of the mobile device 162 to control the grill same as the user would on the control panel 142, including the authentication functionality. Additionally, the application 164 may offer more social networking features, e.g., the user may share recipes, the user's favorite settings and pictures/videos of the resulting cooked food, getting feedback from and giving feedback to friends about the user cooking experience. For example, a user may take pictures and record videos during the cooking process and save the pictures and/or videos and the corresponding recipe/settings for a session. The session data may be uploaded to a social network and shared with friends.

The application 164 communicates with the grill wirelessly, and the communication may through Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox. In some embodiments, cloud 160 implements one or more of these standards, through which the grill communicates with application 164, where commands are issued from application 164 to the control panel 142 to manage the grill.

The control panel 142 and/or application 164 may also provide an interface for a user of the grill to make purchase decisions. For example, the interface may indicate the types of heating materials and liquids, and their pricing information for the user to buy. Additionally, the information provided by the sensors and probes may be used to help with the purchase decisions. For example, the sensors 172 may indicate that heating materials/liquids are insufficient, and the control panel 142 and/or application 164 may then provide an alert to the user, linking to the price and brand information about suitable heating materials/liquids to buy for the grill.

Additionally, the control panel 142 and/or application 164 may also provide an interface for a user of the grill to record the settings/statuses of the grill and the feedback (from the user or network friends of the user) of the corresponding cooking results in a session. The session information may be saved as reference or for adjusting settings in future cooking sessions of the grill through heuristic algorithms or machine learning.

The control panel 142 is an electronic device, and it is powered by a power source 144 for electricity. The power source may be a rechargeable power bank supplying power to the grill to enable standalone portable usage, or a wired power connection to the grill to enable at-home usage. The rechargeable power bank may be inserted into the grill (e.g., at one or more dedicated slots for battery). In some embodiment, the power source 144 may be coupled to a solar power system 147, which may include one or more solar panels and provide direct current (DC) power to the grill. In one embodiment, the rechargeable power bank includes a lithium battery pack.

The grill may also include a set of retractable handles 146 and 148. They can be used to move and store the grill when retracted, and to provide flat surfaces to a user of the grill when extended. The retractable handles, along with the rechargeable power bank, along the grill to be mobile and can be moved to different location easily, the sensors implemented on the grill, such as accelerometer, gyroscope, magnetometer, ambient light sensor, and/or GPS, allows the grill can be tracked and managed remotely.

In the grill system 100, grilling and steaming are integrated into a single system. Such an integrated grill system may grill and steam food as a user prefer. By adjusting air flow vents such as air flow vents 124 and 126, the different level and/or directions of heat generated from the burn pot 136 and liquid box 122 can be obtained, and different favors may be achieved through such adjustment. Additionally, the application on a mobile device allows the grill system to be control wirelessly and remotely, and provide a better user experience than prior grill systems.

In some embodiments, the adjusting air flow vents such as air flow vents 124 and 126 may result in cooking by different percentages of heat from (1) the burn pot 136 through conduction, convection, and/or radiant heat and (2) the liquid box 122 through moist heat (convection and/or radiant heat). In one end of extreme cases, the air flow vent 126 may be shut off (all openings being closed) while the air flow vent 124 remains open, so the minimum moist heat from the liquid box 122 can reach the food on the cooking surface 110, and the food will be cooked primarily through grilling. In another end of the extreme cases, the air flow vent 124 delivering heat from the burn pot 136 (e.g., when the air flow vent 124 may control only the heat level and/or direction from the burn pot 136 or a portion of the air flow 124 control the heat level and/or direction from the burn pot 136) may be shut off while the air flow vent 126 remain open, so the minimum heat from the burn pot 136 can reach the food on the cooking surface 110, and the food will be cooked primly through steaming. By adjusting the air flow vent 124/126, different percentages of heat may be sourced from burn pot 136 and liquid box 122, and such adjustments may result in different flavors and moisture levels.

The adjustment of the air flow vents may be done through heuristic algorithms, and/or the machine learning model, based on food type, personal preference, recipe, sensor data, air flow vent statuses, and/or the historical data on the food type, personal preference, recipe, sensor data, air flow vent statuses. For example, a rule-based heuristic algorithm may have rules to indicate that for cooking vegetables, the heat from the liquid box 122 should be 80% of the total heat reaching the vegetable, and the air flow vent 124/126 may be adjusted to reach the percentage.

For another example, a machine learning model may be developed to adjust the air flow vents. The machine learning takes in the food type, personal preference, recipe, sensor data, air flow vent statuses, and determines how to adjust the air flow vent 124/126 at real-time using one or more machine learning models. The machine learning models may use supervised learning, unsupervised learning, semi-supervised learning, or other types of learning. It can use artificial neural networks, decision trees, support-vector machines, regression analysis, Bayesian networks, genetic algorithms, or any other framework. The machine learning models may be trained with the historical data on the food type, personal preference, recipe, sensor data, air flow vent statuses prior to be applied to the grill.

### Some Embodiments of Grill Systems with Integrated Steaming Capability

FIG. 2 illustrates a grill with integrated steaming capability per some embodiments. The grill 200 includes a cover 202 to cover the body of the grill that the cooking surface 110 implemented as a cast iron grate. The cover 202 may also cover the container 132 to store heating materials. The air flow vent 124 is shown to be adjustable using a flap. The liquid box 122 is shown as extracted so a user may pour in liquid. The waste box 152 is shown as in the inserted state.

Additionally, the grill 200 includes the set of retractable handles 146 and 148 at extended positions, which allow the handles to be doubled as flat surfaces to place food or other items. The control panel 142 shows a knob through which a user of the grill 200 may adjust settings of the grill. The two holes 242 below the control panel 142 are for the user to insert probes, e.g., food probes. As discussed herein above, other than the air flow vents 124 and 126, a grill may have other air flow vents, and FIG. 2 shows an exhaust vent 244 at the side of the grill cover.

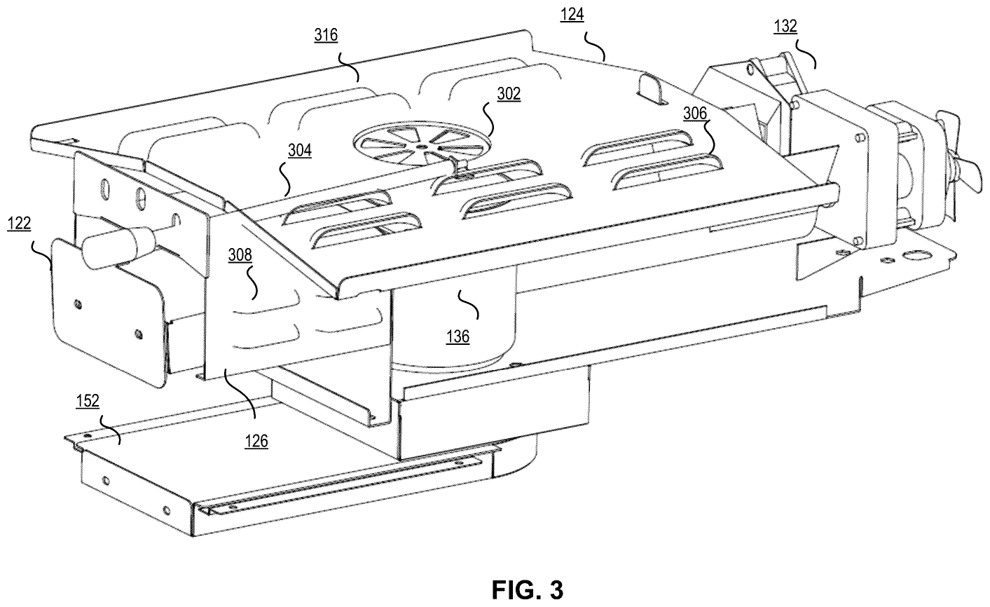

FIG. 3 illustrates an internal view of a grill with integrated steaming capability per some embodiments. Without the grill enclosure, the assembly view shows the components within the grill. The top level is the air flow vent 124 is shown to be adjustable using a flap, where the six apertures 302 may be opened or closed by pushing or pulling a handle 304. Note that the air flow vent 124 also has six vent openings like the vent opening 306 that are in two rows with three vent openings each, and six more vent openings facing the opposite direction of the vent opening 306 as shown at reference 316. A vent opening is redirected through a curved slat that may be tilted at different angles. The tilting is shown is not adjustable, but it can be made adjustable manually or automatically through a motor that is controlled, e.g., by the control panel 142 or the application 164.

The liquid box 122 is again shown in an extracted state, and it is beneath the air flow vent 126 that can adjust the level of steam output through the air flow vent 126 and/or the direction of the steam. Four vent openings of the air flow vent 126 are shown and one of them is referred to at reference 308. The slats of the openings may be similar to or different from the ones at reference 306. Again, the tilting of the slats can be adjusted manually or automatically similar as the one at reference 306.

The burn pot 136 is also shown, and it is positioned above the waste box 152. The burn pot receives heating materials from the container 132.

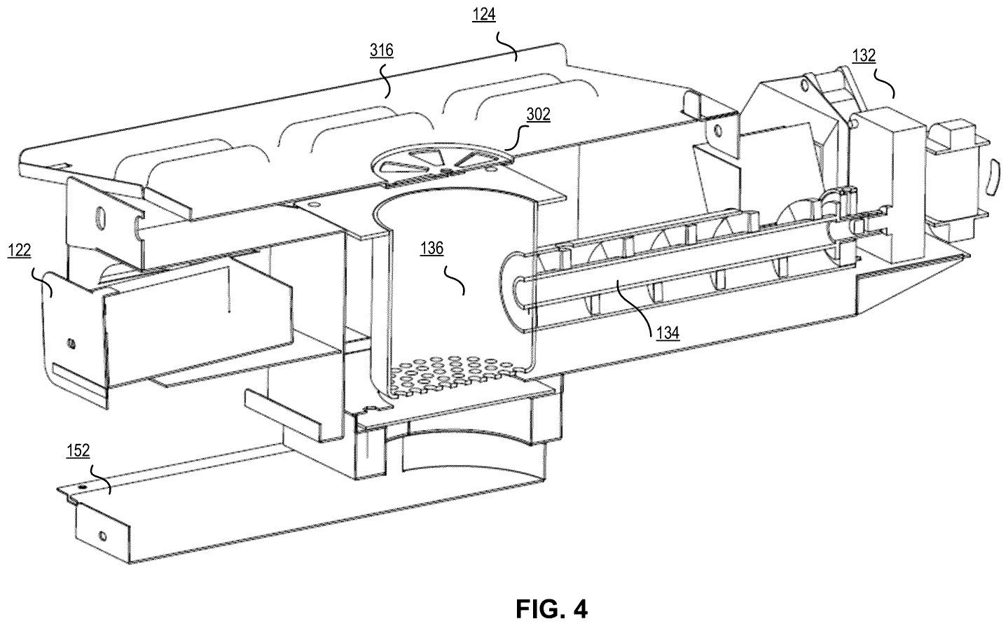

FIG. 4 illustrates a cross-section view of the grill with integrated steaming capability as shown in FIG. 3. The cross-section view further exposes the conduit 134 to deliver heating materials from the container 132 to the burn pot 136.

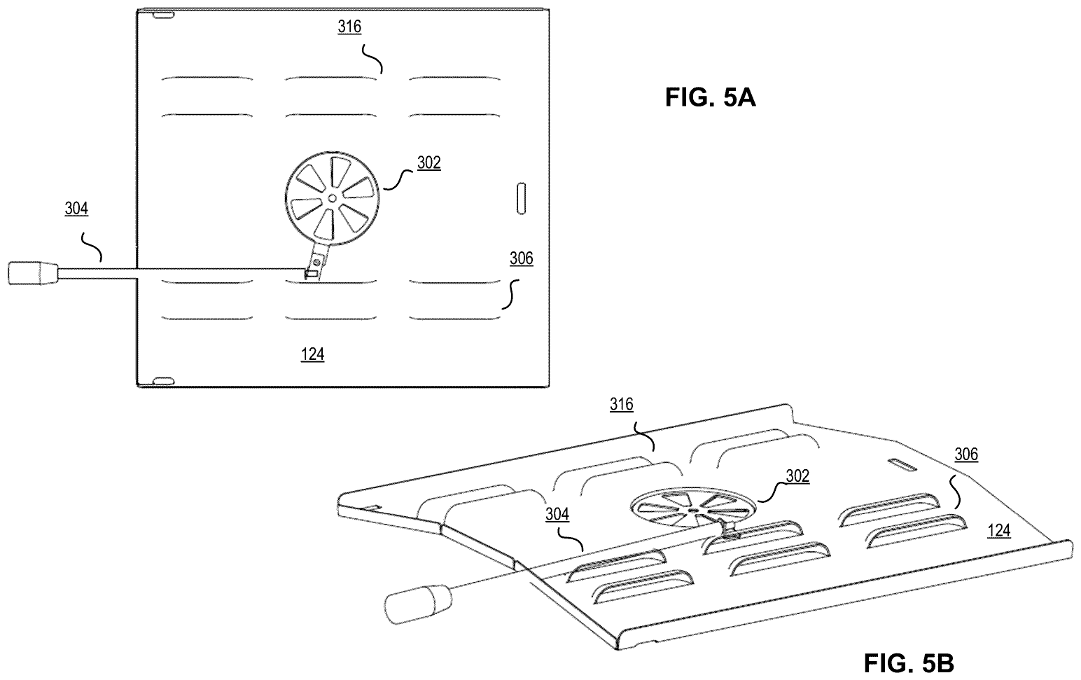

FIGS. 5A-5B illustrate two views of an air flow vent in the grill with integrated steaming capability as shown in FIG. 3. FIG. 5A shows a top-down view while FIG. 5B shows a perspective view.

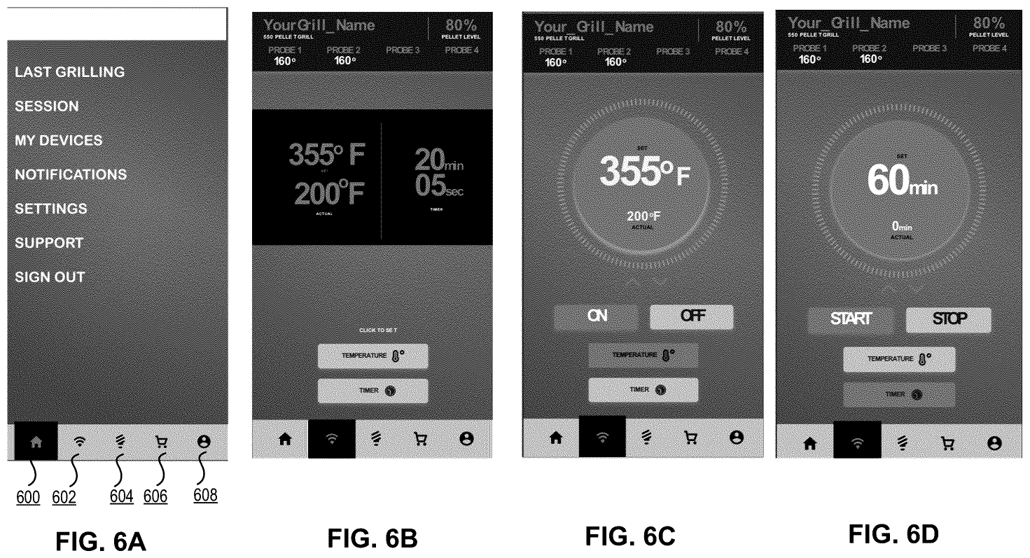

FIGS. 6A-6D illustrate user interfaces to manage a grill system with integrated steaming capability per some embodiments. The user interfaces may be implemented in the control panel 142, the application 164, or another software in an electronic device (e.g., a stationary computer).

FIG. 6A shows a drop-down menu to manage a grill system. The user interface indicates a home screen 600, WiFi 602, Bluetooth 604, purchase cart 606, and user profile 608. The home screen 600 is explained in more details below. The WiFi 602 and Bluetooth 604 shows the wireless connections that a user may select. The purchase cart 606, once expanded, allows a user to make purchase decision that are discussed earlier. The user profile 608 allows a user to set the user preference. For example, a user may save the user preferred setting (cooking temperature, flow rate of the liquid box, and air flow) for a particular type of food.

The home screen 600 is shown as expanded, with tabs for last grilling, session, my devices, notifications, settings, support, and sign out. Through the last grilling tab, the user interface may show the information from the last grilling session. Through the session tab, the user interface may show the history of previous grilling sessions (e.g., the time they occurred and food cooked). Through my devices session, the user interface may add or more grills to manage, and/or show the grills that the user may manage. Through the notification tab, the user interface allows a user to set what types of notifications are to be provided and how (e.g. on locked screen, with/without sound/haptics). Through the setting tab, the user interface may set cooking configuration for both grilling and steaming. Through the support tab, the user interface provides support information of the grill vendor. Through the sign out tab, the user interface provides the path to sign off the application.

FIG. 6B shows an example of the user interface that indicate the status of a grill. In the user interface, the grill name is shown at the top left, and the pellet level is shown at the right (80% of pellets are remaining at the moment). Beneath that, the user interface shows the temperatures of probes, where probe 1 and 2 measures temperature of 160° F. while probes 3 and 4 are inactive. The temperature to reach (“set”) is shown as 355° F. while the current temperature (“actual”) is 200° F. The timer is set to expire in 20 minutes and 05 seconds (“timer”) as shown. Below the temperature and timer, the user interface indicates buttons for a user to press to set temperature and timer.

FIG. 6C shows the setting of temperature, once the user selects to set the temperature (from the interface of FIG. 6B). The setting shows a virtual knob for the user to tune. Once the temperature is selected, the user may press ON to activate the setting or OFF to deactivate an existing temperature setting. FIG. 6D shows the setting of timer, once the user selects to set the timer (from the interface of FIG. 6B). The setting shows a virtual knob for the user to tune. Once the timer is selected, the user may press START to activate the timer or STOP to deactivate an existing timer setting.

Note not all user selections and status information are shown in these user interface examples. For example, the social networking features, the control of the air flow vents and the liquid box.

### Further Examples

Example 1 provides a grill comprising: a heat source to provide heat to a cooking surface; the cooking surface to receive the heat generated by the heat source and to place food to be cooked; a liquid box coupled to the heat source, wherein the liquid box is below the cooking surface and to receive liquid to be heated by the heat source and to produce steam to cook the food; a waste collector to collect wastes produced from cooking the food; an enclosure to enclose the heat source, the cooking surface, the liquid box; and the waste box; a control panel, the control panel to receive commands wirelessly to control how the food is to be cooked; and a power source to provide electricity to the control panel.

Example 2 includes the substance of Example 1, wherein the heat source comprises a burn pot to burn heating materials to provide the heat to cook the cooking surface, and the grill further comprising: a container to store the heating materials; and a conduit to provide the heating materials to the burn pot.

Example 3 includes the substance of Examples 1 to 2, wherein the container comprises a sensor coupled to the container, data collected from which is provided to determine sufficiency of the heating materials to cook the food.

Example 4 includes the substance of Examples 1 to 3, wherein the heating materials comprise wood pellets, charcoal, propane or natural gas, or a combination of wood pellets, charcoal, propane or natural gas.

Example 5 includes the substance of Examples 1 to 4, further comprises an air flow vent to adjust heat level or direction, the air flow vent to be above the heat source and the liquid box, and below the cooking surface.

Example 6 includes the substance of Examples 1 to 5, wherein the heat level or direction is adjustable by the control panel.

Example 7 includes the substance of Examples 1 to 6, wherein a flow rate of the liquid box is adjustable by the control panel.

Example 8 includes the substance of Examples 1 to 7, wherein a sensor is to be coupled to the liquid box, data collected from which is provided to determine sufficiency of liquid in the liquid box to cook the food.

Example 9 includes the substance of Examples 1 to 8, wherein a sensor is to be coupled to the liquid box, data collected from which is provided to determine temperature of the liquid in the liquid box.

Example 10 includes the substance of Examples 1 to 9, wherein an air flow vent is coupled to the liquid box, the air flow vent to adjust level or direction of steam generated from the liquid box.

Example 11 includes the substance of Examples 1 to 10, further comprising: a set of retractable side handles to be used to move and store the grill when retracted, and to provide flat surfaces to a user of the grill when extended.

Example 12 includes the substance of Examples 1 to 11, wherein the power source is coupled to a solar panel, from which direct current (DC) power is obtained.

Example 13 includes the substance of Examples 1 to 12, wherein the commands received wirelessly to control how the food is cooked are from an application operable in a mobile device.

Example 14 includes the substance of Examples 1 to 13, wherein the application is to provide a graphic user interface for a user of the grill to control one or more of a cooking temperature, a flow rate of the liquid box, and air flow within the grill.

Example 15 includes the substance of Examples 1 to 14, wherein the application is to set a cooking temperature, a flow rate of the liquid box, and air flows within the grill automatically based on a recipe provided by a user of the grill without intervention from the user.

Example 16 includes the substance of Examples 1 to 15, wherein the application is to save user preference of the one or more of a cooking temperature, a flow rate of the liquid box, and air flow within the grill.

Example 17 includes the substance of Examples 1 to 16, wherein the application is to store images of the food corresponding to one or more settings of a cooking temperature, a flow rate of the liquid box, and air flow within the grill.

Example 18 includes the substance of Examples 1 to 17, wherein pictures of cooked food and the corresponding one or more settings may be shared to a social media platform.

Example 19 includes the substance of Examples 1 to 18, wherein the application is to indicate one or more statuses of the cooking based on data collected wirelessly from the grill.

Example 20 includes the substance of Examples 1 to 19, wherein the liquid box is to store water, broth, vinegar, milk, sauce, marinade, juice, liquor, cider, or any combination of aforementioned liquids.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein can refer to any whole number of items including one item.

Although the systems described herein may include the illustrated combination of hardware components, other embodiments may comprise systems with different combinations of components. It is to be understood that these systems may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, systems may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

A system (such as the grill system 100) include electronic devices to store and transmit (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., the control panel 142) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses (e.g., application 164 in the mobile device 162). Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

What is claimed is:

1. A grill comprising:
a heat source to provide heat to a cooking surface;
the cooking surface to receive the heat generated by the heat source and to place food to be cooked;
a liquid box coupled to the heat source, wherein the liquid box is below the cooking surface and to receive liquid to be heated by the heat source and to produce steam to cook the food;
a waste collector to collect wastes produced from cooking the food;
an enclosure to enclose the heat source, the cooking surface, the liquid box; and the waste collector;
a control panel, the control panel to receive commands wirelessly to control how the food is to be cooked; and
a power source to provide electricity to the control panel.

2. The grill of claim 1, wherein the heat source comprises a burn pot to burn heating materials to provide the heat to cook the cooking surface, and the grill further comprising:
a container to store the heating materials; and
a conduit to provide the heating materials to the burn pot.

3. The grill of claim 2, wherein the container comprises a sensor coupled to the container, data collected from which is provided to determine sufficiency of the heating materials to cook the food.

4. The grill of claim 2, wherein the heating materials comprise wood pellets, charcoal, propane or natural gas, or a combination of wood pellets, charcoal, propane or natural gas.

5. The grill of claim 1, further comprises an air flow vent to adjust heat level or direction, the air flow vent to be above the heat source and the liquid box, and below the cooking surface.

6. The grill of claim 5, wherein the heat level or direction is adjustable by the control panel.

7. The grill of claim 1, wherein a flow rate of the liquid box is adjustable by the control panel.

8. The grill of claim 1, wherein a sensor is to be coupled to the liquid box, data collected from which is provided to determine sufficiency of liquid in the liquid box to cook the food.

9. The grill of claim 1, wherein a sensor is to be coupled to the liquid box, data collected from which is provided to determine temperature of the liquid in the liquid box.

10. The grill of claim 1, wherein an air flow vent is coupled to the liquid box, the air flow vent to adjust level or direction of steam generated from the liquid box.

11. The grill of claim 1, further comprising:
a set of retractable side handles to be used to move and store the grill when retracted, and to provide flat surfaces to a user of the grill when extended.

12. The grill of claim 1, wherein the power source is coupled to a solar panel, from which direct current (DC) power is obtained.

13. The grill of claim 1, wherein the commands received wirelessly to control how the food is cooked are from an application operable in a mobile device.

14. The grill of claim 13, wherein the application is to provide a graphic user interface for a user of the grill to control one or more of a cooking temperature, a flow rate of the liquid box, and air flow within the grill.

15. The grill of claim 13, wherein the application is to set a cooking temperature, a flow rate of the liquid box, and air flows within the grill automatically based on a recipe provided by a user of the grill without intervention from the user.

16. The grill of claim 13, wherein the application is to save user preference of the one or more of a cooking temperature, a flow rate of the liquid box, and air flow within the grill.

17. The grill of claim 13, wherein the application is to store images of the food corresponding to one or more settings of a cooking temperature, a flow rate of the liquid box, and air flow within the grill.

18. The grill of claim 17, wherein pictures of cooked food and the corresponding one or more settings may be shared to a social media platform.

19. The grill of claim 13, wherein the application is to indicate one or more statuses of the cooking based on data collected wirelessly from the grill.

20. The grill of claim 1, wherein the liquid box is to store water, broth, vinegar, milk, sauce, marinade, juice, liquor, cider, or any combination of aforementioned liquids.
